(19) United States
(12) Patent Application Publication
(10) Pub. No.: US 2019/0049764 A1
(43) Pub. Date: Feb. 14, 2019

(54) Sealing Method, Sealing Structure, and Display Device

(71) Applicants: HKC Corporation Limited, Shenzhen (CN); Chongqing HKC Optoelectronics Technology Co., Ltd., Chongqing (CN)

(72) Inventor: Yu-Jen Chen, Chongqing (CN)

(21) Appl. No.: 15/566,537

(22) PCT Filed: Jul. 3, 2017
(86) PCT No.: PCT/CN2017/091507

§ 371 Date: Oct. 13, 2017

(30) Foreign Application Priority Data
Mar. 10, 2017 (CN) 201710142950.1

(51) Int. Cl. G02F 1/1339; G02F 1/1333

(52) U.S. Cl. CPC G02F 1/1339; G02F 1/133308; G02F 2001/133325; G02F 2202/28; G02F 2001/133311; G02F 2001/133314

(57) ABSTRACT

A sealing method, a sealing structure, and a display device are provided. The method includes: providing a display panel, a first adhesive, and a bezel, wherein the bezel includes a sidewall and a supporting wall; disposing an engagement slot on the sidewall, and disposing a through hole at a bottom surface of the engagement slot; making a side of the display panel be attached to an upper side of the supporting wall, thereby forming a first contact surface between the display panel and the supporting wall, and forming a second contact surface between the display panel and the sidewall; filling the engagement slot, the through hole, the first contact surface, the second contact surface, and an outer side surface of the display panel with the first adhesive; and curing the first adhesive, so as to securely join the display panel and the bezel.

### CROSS-REFERENCE TO RELATED APPLICATION

This application claims the benefit of China Patent Application No. 201710142950.1, filed on Mar. 10, 2017, in the State Intellectual Property Office of the People's Republic of China, the disclosure of which is incorporated herein in its entirety by reference.

### BACKGROUND OF THE INVENTION

### 1. Field of the Invention

The present application is related to the display technology; and more specifically, the present application is related to a sealing method, a sealing structure, and a display device.

### 2. Description of the Related Art

As the breakthrough are constantly being made on various types of display devices, the bar for the display device bezel is constantly raised as well, and this trend gradually leads to a display device with narrow-bezel or bezel-less design. In the state of the art, the display panel and the bezel are fixed together by means of screws; however, this kind of fixing method tends to result in excessively wide bezel. On the other hand, if the display panel and the bezel are to be simply glued together, the gap between the display panel and the bezel may not be covered, and the dust may get into the interior of the display device, thereby shortening the lifespan of display panel; apart from that, since the attachment between the display panel and the bezel may not be secured enough, the display panel may detach from the bezel, and the product quality is compromised.

### SUMMARY OF THE INVENTION

The present application provides a sealing method, sealing structure, and display device that are reliable, which can achieve the results of narrow-bezel or bezel-less device.

In one aspect, the present application provides a sealing method, which may include the steps of:

providing a display panel, a first adhesive, and a bezel, wherein the bezel may include a sidewall and a supporting wall;

disposing an engagement slot on the sidewall, and disposing a through hole at a bottom surface of the engagement slot;

making a side of the display panel be attached to an upper side of the supporting wall, thereby forming a first contact surface between the display panel and the supporting wall, and forming a second contact surface between the display panel and the sidewall;

filling the engagement slot, the through hole, the first contact surface, the second contact surface, and an outer side surface of the display panel with the first adhesive; and

curing the first adhesive, so as to securely join the display panel and the bezel.

Apart from that, the other aspect of the present application provides a sealing structure, which may include:

a bezel, which may include a sidewall and a supporting wall, the sidewall may be disposed with an engagement slot, and a bottom surface of the engagement slot may be disposed with a through hole;

a display panel, a side of the display panel may be attached to the upper side of the supporting wall, a first contact surface may be formed between the display panel and the supporting wall, and a second contact surface may be formed between the display panel and the sidewall; and a first adhesive filling the engagement slot, the through hole, the first contact surface, the second contact surface, and an outer side surface of the display panel, so as to securely join the display panel and the bezel.

In addition, another aspect of the present application also provides a display device, which may include a base, a back frame, and a sealing structure; the sealing structure may include:

a bezel, which may include a sidewall and a supporting wall, the sidewall may be disposed with an engagement slot, and a bottom surface of the engagement slot may be disposed with a through hole;

a display panel, a side of the display panel may be attached to the upper side of the supporting wall, a first contact surface may be formed between the display panel and the supporting wall, and a second contact surface may be formed between the display panel and the sidewall; and

a first adhesive filling the engagement slot, the through hole, the first contact surface, the second contact surface, and an outer side surface of the display panel, so as to securely join the display panel and the bezel;

the sealing structure may further include an adhesive mixture spread on the first adhesive, and the adhesive mixture may include a second adhesive and a colorant.

In the embodiment of the present application, an engagement slot is disposed on the sidewall of the bezel, and a through hole is disposed at the bottom surface of the engagement slot; by filling the engagement slot, the through hole, the first contact surface, the second contact surface, and the outer side surface of the display panel with the first adhesive, the display panel can be securely joined to the bezel.

Through the embodiments of the present application, the display panel can be securely joined to the bezel, and the display device can achieve the effect of narrow-bezel or bezel-less.

### BRIEF DESCRIPTION OF THE DRAWINGS

In order to illustrate the technical feature of the present application in a clear manner, brief introductions for the drawings that accompany the illustrations of the embodiments will be given hereinafter; it is appreciated that the following drawings are merely for some embodiments of the present application, and a person skilled in the art can come up with other drawings according to the drawings provided herein without much inventive endeavors.

FIG. 1 is a flowchart for one embodiment of the sealing method of the present application;

FIG. 2 is a flowchart for one embodiment of the sealing method of the present application;

FIG. 3 is a schematic diagram illustrating the 3D structure of the sealing structure according to one embodiment of the present application;

FIG. 4 is a schematic diagram illustrating the 3D structure of the bezel of the sealing structure according to one embodiment of the present application;

FIG. 5 is a schematic diagram illustrating the 3D structure of the bezel of the sealing structure according to one embodiment of the present application;

FIG. 6 is a schematic diagram illustrating the cross-section of the sealing structure according to one embodiment of the present application;

FIG. 7 is a schematic diagram illustrating the cross-section of the sealing structure according to one embodiment of the present application;

FIG. 8 is a schematic diagram illustrating the structure of the display device according to one embodiment of the present application.

### DESCRIPTION OF THE PREFERRED EMBODIMENTS

The following contents combined with the drawings for the embodiments of the present application serve to illustrate the technical features of the present application in a clear and thorough manner. It is apparent that the embodiments discoursed hereinafter is just part of the embodiments of the present application, and should not be construed as all of the embodiments of the present application. It is understood that any other embodiments that are derived from what is disclosed within this application without contributing any inventive endeavor, shall fall within the scope the present application claims.

It is also understood that the terms “comprise” and “include”, when used in this specification, specify the presence of stated features, integers, steps, operations, elements, and/or components, but do not preclude the presence or addition of one or more other features, integers, steps, operations, elements, components, and/or groups thereof.

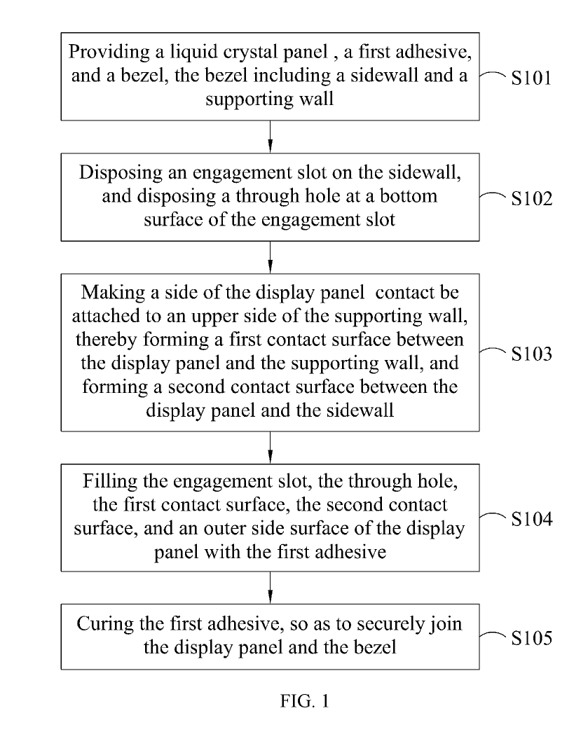

Referring to FIG. 1, which is a flowchart for one embodiment of the sealing method of the present application. As shown in the drawing, the sealing method may include, but not limited to, Steps S101-S105.

Step S101: providing a display panel, a first adhesive, and a bezel; the bezel may include a sidewall and a supporting wall.

In a practical embodiment, in order to achieve better visual effect with narrow bezel and to meet the robustness requirement of the bezel, the bezel of the present embodiment may be made of plastic or metal through extrusion or casting. The types of display panel may include, but not limited to, Liquid Crystal Display (LCD), Organic Light-Emitting Diode (OLED), Field Emission Display (FED), Plasma Display Panel (PDP), or curved display panel. The types of LCD panel may include Thin Film Transistor-Liquid Crystal Display (TFT-LCD), Twisted Nematic+Film (TN), Vertical Alignment (VA), In-Plane Switching (IPS), Color Filter on Array (COA), etc.

In addition, the first adhesive may be a UV-curable adhesive.

Furthermore, the sidewall and the supporting wall may form an angle. For instance, the sidewall and the supporting wall may be perpendicular to each other.

Step S102: disposing an engagement slot on the sidewall, and disposing a through hole at a bottom surface of the engagement slot.

In a practical embodiment, there may be one or more engagement slots. For instance, the quantity of the engagement slot may be two. The position where the engagement slot is disposed is not limited to what is disclosed in the present embodiment; the engagement slot may also be disposed at the sides or the middle of the bezel.

The through hole may be a rectangular hole, a circular hole, a polygonal hole, etc., and the shape of the through hole is not limited to what is disclosed in the present embodiment.

The size of the through hole may be smaller than the size of the bottom surface of the engagement slot.

Step S103: making the side of the display panel be attached to the upper side of the supporting wall, thereby forming a first contact surface between the display panel and the supporting wall, and forming a second contact surface between the display panel and the sidewall.

In a practical embodiment, the through hole may form a connected space between the second contact surface and the engagement slot.

Step S104: filling the engagement slot, the through hole, the first contact surface, the second contact surface, and an outer side surface of the display panel with the first adhesive.

Step S105: curing the first adhesive, so as to securely join the display panel and the bezel.

In one practical embodiment, after being cured, the first adhesive may join the display panel and the bezel via the adhesiveness thereof. In addition, through the curing of the first adhesive and the engaging mechanism of the engagement slot, the display panel and the bezel may be securely joined in a more effective manner, thereby strengthening the joint.

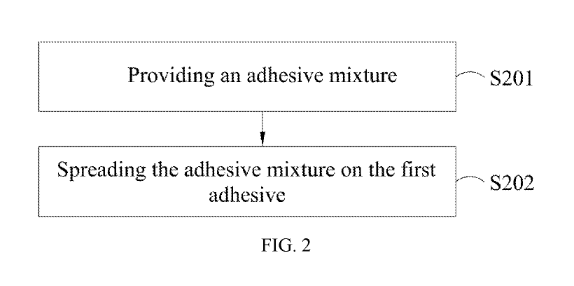

Referring to FIG. 2, which is a flowchart for one embodiment of the sealing method of the present application. Further, the sealing method may include, but not limited to, Steps S201-S202.

Step 201: providing an adhesive mixture; the adhesive mixture may include a second adhesive and a colorant, and the second adhesive and the first adhesive may be identical adhesives.

In one practical embodiment, the first adhesive and the second adhesive may be the same type of adhesive, for example, the ultraviolet-curable (UV-curable) adhesive. The color of the colorant may be selected based on the color of the bezel. For instance, the colorant may be of the same color as the bezel.

Step 202: spreading the adhesive mixture on the first adhesive.

Through the embodiment of the present application, the adhesive mixture is spread on the first adhesive, and the joint between the display panel and the bezel can look smoother and more natural. The blend of colorant in the adhesive mixture is capable of preventing dust from outside from entering the interior of the display device having the display panel, and the aesthetic effect of the bezel may be improved.

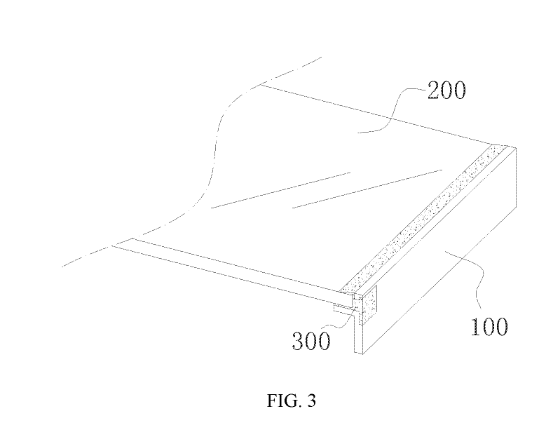

Referring to FIG. 3, which is a schematic diagram illustrating the 3D structure of the sealing structure according to one embodiment of the present application. The sealing structure may include a bezel 100, a display panel 200, and a first adhesive 300.

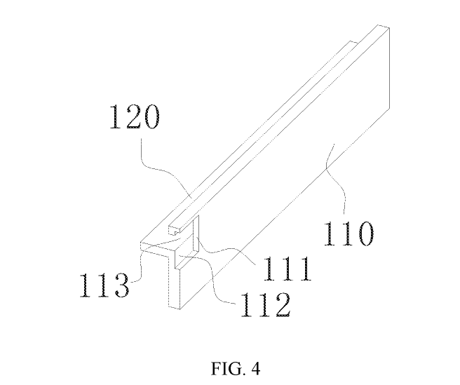

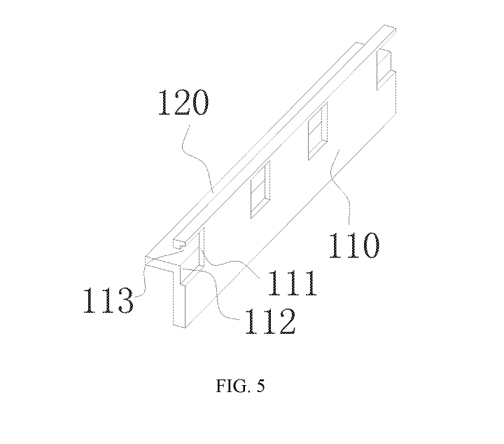

Referring to FIGS. 4 and 5, which are the schematic diagrams illustrating the 3D structure of the bezel of the sealing structure according to one embodiment of the present application. The bezel 100 may include a sidewall 110 and a supporting wall 120; the sidewall 110 may be disposed with an engagement slot 111, and a bottom surface 112 of the engagement slot 111 may be disposed with a through hole 113.

In a practical embodiment, there may be one or more engagement slots 111. For instance, the quantity of the engagement slot 111 may be two. In particular, the bezel 100 as shown in FIG. 5 may be disposed with four engagement slots 111. The position where the engagement slot 111 is disposed is not limited to what is disclosed in the present embodiment; the engagement slot 111 may also be disposed at the sides or the middle of the bezel 100. In order to achieve better visual effect with narrow bezel 100 and to meet the robustness requirement of the bezel 100, the bezel 100 of the present embodiment may be made of plastic or metal through extrusion or casting.

The through holes 113 may be a rectangular hole, a circular hole, a polygonal hole, etc., the shape of the through hole 113 is not limited to what is disclosed in the present embodiment.

Furthermore, the size of the through holes 113 may be smaller than the size of the bottom surface 112 of the engagement slot 111.

Furthermore, the sidewall 110 and the supporting wall 120 may form an angle. For instance, the sidewall 110 and the supporting wall 120 may be perpendicular to each other.

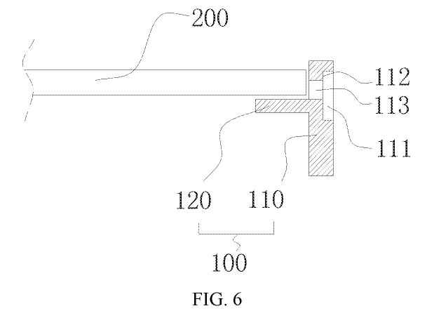

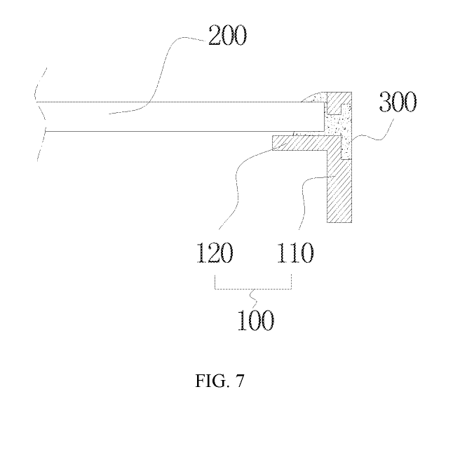

Referring to FIGS. 6 and 7, which are the schematic diagrams illustrating the cross-sections of the sealing structure according to one embodiment of the present application. More specifically, the cross-sectional diagram for the sealing structure shown FIG. 6 is a structural schematic diagram prior to the filling of the first adhesive 300, while the cross-sectional diagram for the sealing structure shown FIG. 7 is a structural schematic diagram following to the filling of the first adhesive 300.

The side of the display panel 200 may be attached to the upper side of the supporting wall 120, a first contact surface may be formed between the display panel 200 and the supporting wall 120, and a second contact surface may be formed between the display panel 200 and the sidewall 110.

In a practical embodiment, the through hole 113 may form a connected space between the second contact surface and the engagement slot 111.

More specifically, the types of display panel 200 may include, but not limited to, Liquid Crystal Display (LCD), Organic Light-Emitting Diode (OLED), Field Emission Display (FED), Plasma Display Panel (PDP), or curved display panel. The types of LCD panel may include Thin Film Transistor-Liquid Crystal Display (TFT-LCD), Twisted Nematic+Film (TN), Vertical Alignment (VA), In-Plane Switching (IPS), Color Filter on Array (COA), etc.

The first adhesive 300 may fill the engagement slot 111, the through hole 113, the first contact surface, the second contact surface, and the outer side surface of the display panel 200, so as to securely join the display panel 200 and the bezel 100.

In one practical embodiment, after being cured, the first adhesive 300 may join the display panel 200 and the bezel 100 via the adhesiveness thereof. In addition, through the curing of the first adhesive 300 and the engaging mechanism of the engagement slot 111, the display panel 200 and the bezel 100 may be securely joined in a more effective manner, thereby strengthening the joint.

In other embodiments, the sealing structure may further include an adhesive mixture spread on the first adhesive 300, and the adhesive mixture may include a second adhesive and a colorant.

In one practical embodiment, the first adhesive 300 and the second adhesive may be the same type of adhesive, for example, the ultraviolet-curable (UV-curable) adhesive. The color of the colorant may be selected based on the color of the bezel 100. For instance, the colorant may be of the same color as the bezel 100.

Through the embodiment of the present application, the adhesive mixture is spread on the first adhesive 300, and the joint between the display panel 200 and the bezel 100 can look smoother and more natural. The blend of colorant in the adhesive mixture is capable of preventing dust from outside from entering the interior of the display device having the display panel 200, and the aesthetic effect of the bezel 100 may be improved.

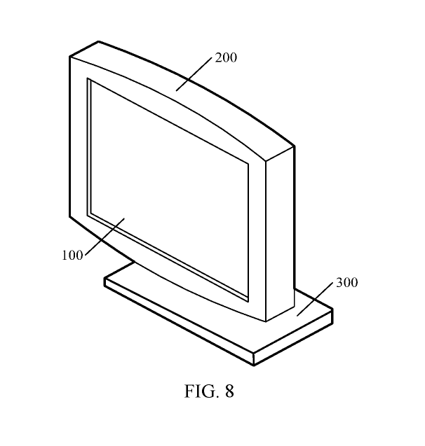

Referring to FIG. 8, which is a schematic diagram illustrating the structure of the display device according to one embodiment of the present application. The display device 900 may include a back frame 910, a base 920, and a sealing structure 930.

The sealing structure 930 may include a bezel, which may include a sidewall and a supporting wall. The sidewall may be disposed with an engagement slot, and a bottom surface of the engagement slot may be disposed with a through hole.

In a practical embodiment, there may be one or more engagement slots. For instance, the quantity of the engagement slot may be two. The position where the engagement slot is disposed is not limited to what is disclosed in the present embodiment; the engagement slot may also be disposed at the sides or the middle of the bezel. In order to achieve better visual effect with narrow bezel and to meet the robustness requirement of the bezel, the bezel of the present embodiment may be made of plastic or metal through extrusion or casting.

The through hole may be a rectangular hole, a circular hole, a polygonal hole, etc., and the shape of the through hole is not limited to what is disclosed in the present embodiment.

Furthermore, the size of the through hole may be smaller than the size of the bottom surface of the engagement slot.

Furthermore, the sidewall and the supporting wall may form an angle. For instance, the sidewall and the supporting wall may be perpendicular to each other.

A side of the display panel may be attached to the upper side of the supporting wall; a first contact surface may be formed between the display panel and the supporting wall, and a second contact surface may be formed between the display panel and the sidewall.

In a practical embodiment, the through hole may form a connected space between the second contact surface and the engagement slot.

More specifically, the types of display panel may include, but not limited to, Liquid Crystal Display (LCD), Organic Light-Emitting Diode (OLED), Field Emission Display (FED), Plasma Display Panel (PDP), or curved display panel. The types of LCD panel may include Thin Film Transistor-Liquid Crystal Display (TFT-LCD), Twisted Nematic+Film (TN), Vertical Alignment (VA), In-Plane Switching (IPS), Color Filter on Array (COA), etc.

A first adhesive may fill the engagement slot, the through hole, the first contact surface, the second contact surface, and an outer side surface of the display panel, so as to securely join the display panel and the bezel.

In one practical embodiment, after being cured, the first adhesive may join the display panel and the bezel via the adhesiveness thereof. In addition, through the curing of the first adhesive and the engaging mechanism of the engagement slot, the display panel and the bezel may be securely joined in a more effective manner, thereby strengthening the joint.

In addition, the sealing structure 930 may further include an adhesive mixture, which may be spread on the first adhesive; the adhesive mixture may include a second adhesive and a colorant, and the first and second adhesive may be UV-curable adhesives.

In one practical embodiment, the first adhesive and the second adhesive may be the same type of adhesive, for example, the ultraviolet-curable (UV-curable) adhesive. The color of the colorant may be selected based on the color of the bezel. For instance, the colorant may be of the same color as the bezel.

Through the embodiment of the present application, the adhesive mixture is spread on the first adhesive, and the joint between the display panel and the bezel can look smoother and more natural. The blend of colorant in the adhesive mixture is capable of preventing dust from outside from entering the interior of the display device 900, and the aesthetic effect of the bezel may be improved.

It should be noted that, for brevity, the foregoing method embodiments are described as a series of actions; however, persons skilled in the art should understand that the present application is not limited to the order of the described actions, because some steps may be performed in another order or simultaneously according to the present application. It should be further understood by persons skilled in the art that the described embodiments all belong to exemplary embodiments, and the involved actions and modules are not necessarily required by the present application.

In the foregoing embodiments, the description of each embodiment has its emphasis, and for a part that is not described in detail in a certain embodiment, reference may be made to the relevant description of other embodiments.

The steps in the method provided in the embodiment of the present application may be reordered, combined and omitted according to a practical need.

The foregoing descriptions are merely specific exemplary embodiments of the present application, and they are not intended to limit the protection scope of the present invention; any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A sealing method, comprising steps of:
providing a display panel, a first adhesive, and a bezel, wherein the bezel comprises a sidewall and a supporting wall;
disposing an engagement slot on the sidewall, and disposing a through hole at a bottom surface of the engagement slot;
making a side of the display panel be attached to an upper side of the supporting wall, thereby forming a first contact surface between the display panel and the supporting wall, and forming a second contact surface between the display panel and the sidewall;
filling the engagement slot, the through hole, the first contact surface, the second contact surface, and an outer side surface of the display panel with the first adhesive; and
curing the first adhesive, so as to securely join the display panel and the bezel.

2. The sealing method of claim 1, further comprising steps of:
providing an adhesive mixture, the adhesive mixture comprising a second adhesive and a colorant, wherein the second adhesive and the first adhesive are identical adhesives; and
spreading the adhesive mixture on the first adhesive.

3. The sealing method of claim 1, wherein a size of the through hole is smaller than a size of the bottom surface of the engagement slot.

4. The sealing method of claim 1, wherein a quantity of the engagement slot is at least two.

5. The sealing method of claim 1, wherein the sidewall and the supporting wall are perpendicular to each other.

6. The sealing method of claim 1, wherein the first adhesive is a UV-curable adhesive.

7. The sealing method of claim 2, wherein the second adhesive is a UV-curable adhesive.

8. A sealing structure, comprising:
a bezel, the bezel comprising a sidewall and a supporting wall, the sidewall being disposed with an engagement slot, and a bottom surface of the engagement slot being disposed with a through hole;
a display panel, a side of the display panel contacting an upper side of the supporting wall, a first contact surface being formed between the display panel and the supporting wall, and a second contact surface being formed between the display panel and the sidewall; and
a first adhesive, the first adhesive filling the engagement slot, the through hole, the first contact surface, the second contact surface, and an outer side surface of the display panel, so as to securely join the display panel and the bezel.

9. The sealing structure of claim 8, wherein the sealing structure further comprises an adhesive mixture, the adhesive mixture is spread on the first adhesive, and the adhesive mixture comprises a second adhesive and a colorant.

10. The sealing structure of claim 8, wherein a size of the through hole is smaller than a size of the bottom surface of the engagement slot.

11. The sealing structure of claim 8, wherein a quantity of the engagement slot is at least two.

12. The sealing structure of claim 8, wherein the sidewall and the supporting wall are perpendicular to each other.

13. The sealing structure of claim 8, wherein the first adhesive is a UV-curable adhesive.

14. The sealing structure of claim 8, wherein the second adhesive is a UV-curable adhesive.

15. A display device, comprising a base, a back frame, and a sealing structure, the sealing structure comprising:
a bezel, the bezel comprising a sidewall and a supporting wall, the sidewall being disposed with an engagement slot, and a bottom surface of the engagement slot being disposed with a through hole;
a display panel, a side of the display panel contacting an upper side of the supporting wall, a first contact surface being formed between the display panel and the supporting wall, and a second contact surface being formed between the display panel and the sidewall; and
a first adhesive, the first adhesive filling the engagement slot, the through hole, the first contact surface, the second contact surface, and an outer side surface of the display panel, so as to securely join the display panel and the bezel;
wherein the sealing structure further comprises an adhesive mixture, the adhesive mixture is spread on the first adhesive, and the adhesive mixture comprises a second adhesive and a colorant.

16. The display device of claim 15, wherein a size of the through hole is smaller than a size of the bottom surface of the engagement slot.

17. The display device of claim 15, wherein a quantity of the engagement slot is at least two.

18. The display device of claim 15, wherein the sidewall and the supporting wall are perpendicular to each other.

19. The display device of claim 15, wherein the first adhesive is a UV-curable adhesive.

20. The display device of claim 15, wherein the second adhesive is a UV-curable adhesive.
